(19) United States
(12) Patent Application Publication
(10) Pub. No.: US 2009/0257468 A1
(43) Pub. Date: Oct. 15, 2009

(54) COMMUNICATION DEVICES THAT INCLUDE A COHERENT LIGHT SOURCE CONFIGURED TO PROJECT LIGHT THROUGH A TRANSLUCENT PORTION OF A HOUSING AND METHODS OF OPERATING THE SAME

(76) Inventor: David Michael McMahan, Raleigh, NC (US)

Correspondence Address: MYERS BIGEL SIBLEY & SAJOVEC, P.A., P.O. BOX 37428, RALEIGH, NC, 27627, US

(21) Appl. No.: 12/103,448

(22) Filed: Apr. 15, 2008

(51) Int. Cl. H01S 3/00

(52) U.S. Cl. 372/107

(57) ABSTRACT

A communication device includes communication circuitry, a coherent light source, and a housing that at least partially surrounds the communication circuitry and the coherent light source. The housing includes a translucent portion and the coherent light source is configured so as to project light through the translucent portion of the housing.

### BACKGROUND OF THE INVENTION

The present invention relates to communication devices, and, more particularly, to the use of coherent light to enhance the aesthetic appeal of communication devices.

Communication devices, such as mobile phones or terminals, have become more than just a utility device for making and receiving phone calls. Mobile phones may provide social status and make a social statement about the person carrying the phone. For some users, it is important for a phone to reflect the image that the user wishes to project to others. If the phone is perceived as unique and desirable, then the person carrying the phone may hope that he/she will also be viewed in the same way.

For some users, the amount of “flash” in a phone is important. These users often prefer eye catching devices. Users may look for a visually appealing combination of colors and light patterns that call attention to the phone and to the owner who carries it.

### SUMMARY OF THE INVENTION

According to some embodiments of the present invention, a communication device includes communication circuitry, a coherent light source, and a housing that at least partially surrounds the communication circuitry and the coherent light source. The housing includes a translucent portion and the coherent light source is configured so as to project light through the translucent portion of the housing.

In other embodiments of the present invention, the housing further includes an opaque portion that is configured to substantially block light from the light source from passing through the housing.

In still other embodiments of the present invention, the communication device further includes at least one optical component that is configured to direct the light projected from the coherent light source.

In still other embodiments of the present invention, the at least one optical component includes a diffraction grating, a lens, glitter, and/or a mirror.

In still other embodiments of the present invention, the housing includes the at least one optical component.

In still other embodiments, the at least one optical component is operable to move responsive to an excitation signal.

In still other embodiments, the communication device further includes an audio module that is configured to generate the excitation signal.

In still other embodiments, the housing has an inner surface and an outer surface with both the inner and outer surfaces being substantially smooth.

In still other embodiments of the present invention, the housing has an inner surface and an outer surface with at least one of the inner and outer surfaces being distressed.

In still other embodiments of the present invention, the translucent portion of the housing is manipulated such that a polarization of the light passing through the translucent housing is changed.

In still other embodiments of the present invention, the communication device further includes a non-coherent light source. The housing at least partially surrounds the non-coherent light source and the non-coherent light source is configured so as to project light through the translucent portion of the housing.

In still other embodiments of the present invention, the coherent light source is a laser diode.

In still other embodiments of the present invention, the communication device further includes a frequency modulator that is configured to generate an output signal. The coherent light source is configured to project light at a frequency that is based on the output signal of the frequency modulator.

In still other embodiments of the present invention, the communication device further includes an audio module that is configured to generate an audio signal. The frequency modulator is configured to generate the output signal responsive to the audio signal.

In still other embodiments of the present invention, the communication device further includes a power control module that is configured to modulate power to the coherent light source.

In still further embodiments of the present invention, the communication device further includes an ambient light sensor that is configured to generate an output signal based on an intensity of environmental light. The power control module is configured to modulate power to the coherent light source responsive to the output signal of the ambient light sensor.

In still further embodiments of the present invention, the communication device further includes a heat control module that is configured to generate an output signal based on a temperature internal to the communication device. The power control module is configured to modulate power to the coherent light source responsive to the output signal of the heat control module.

In still other embodiments of the present invention, the communication device is a mobile terminal.

In further embodiments of the present invention, a communication device is operated by at least partially surrounding communication circuitry and a coherent light source with a housing, which includes a translucent portion. Light is projected from the coherent light source through the translucent portion of the housing.

In still further embodiments of the present invention, the housing further includes an opaque portion that is configured to substantially block light from the light source from passing through the housing.

In still further embodiments of the present invention, the method further includes directing the light projected from the coherent light source using at least one optical component.

In still further embodiments of the present invention, the method further includes moving at least one optical component responsive to an excitation signal.

In still further embodiments of the present invention, the excitation signal is an audio signal.

In still further embodiments of the present invention, the method further includes manipulating the translucent portion of the housing such that a polarization of the light passing through the translucent portion of the housing is changed.

In still further embodiments of the present invention, the housing at least partially surrounds a non-coherent light source. The method further includes projecting light from the non-coherent light source through the translucent portion of the housing.

In still further embodiments of the present invention, the method further includes using a frequency modulator to generate an output signal and operating the coherent light source to generate light at a frequency that is based on the output signal of the frequency modulator.

In still further embodiments of the present invention, the communication device is a mobile terminal.

### BRIEF DESCRIPTION OF THE DRAWINGS

Other features of the present invention will be more readily understood from the following detailed description of specific embodiments thereof when read in conjunction with the accompanying drawings, in which:

FIG. 1 is a diagram of a mobile terminal that includes a housing with a translucent portion in accordance with some embodiments of the present invention;

FIG. 2 is a block diagram that illustrates a mobile terminal in accordance with some embodiments of the present invention; and

FIG. 3 is a diagram that illustrates the projection of coherent light through the translucent portion of a housing of a mobile terminal in accordance with some embodiments of the present invention.

### DETAILED DESCRIPTION OF EMBODIMENTS

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures.

As used herein, the singular forms “a,” “an,” and “the” are intended to include the plural forms as well, unless expressly stated otherwise. It should be further understood that the terms “comprises” and/or “comprising” when used in this specification is taken to specify the presence of stated features, integers, steps, operations, elements, and/or components, but does not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

Embodiments of the present invention are described herein in the context of a communication device that comprises communication circuitry, a coherent light source, and a housing that includes a translucent portion through which the coherent light may be projected. A communication device may be any device that is capable of communication over a communication medium and/or communication interface. The communication medium and/or communication interface may be, for example, but is not limited to, a wireless medium, a wireline medium, a networked interface, such as a local and/or wide area network, a direct interface, such as a serial/parallel port interface and/or a PCMCIA interface, and a bus interface, such as a universal serial bus (USB) connection and/or peripheral component interconnect (PCI). Examples of communication devices can include, but is not limited to such devices as MP-3 or other audio format players, video players, memory sticks, wired and/or wireless headsets, electronic toys and/or games that provide video, audio, and/or textual communication with a user or other device, etc.

In some embodiments of the present invention, a communication device may be a mobile terminal. As used herein, the term “mobile terminal” includes, but is not limited to, any electronic device that is configured to transmit/receive communication signals with a long range wireless interface such as, for example, a cellular interface and/or Wi Fi interface, and/or via a short range wireless interface such as, for example, a Bluetooth wireless interface, a wireless local area network (WLAN) interface, such as IEEE 801.11a-g, and/or another radio frequency (RF) interface. The term “mobile terminal” may include a satellite or cellular radiotelephone with or without a multi-line display; a Personal Communications System (PCS) terminal that may combine a cellular radiotelephone with data processing, facsimile and data communications capabilities; a PDA that can include a radiotelephone, pager, Internet/intranet access, Web browser, organizer, calendar and/or a global positioning system (GPS) receiver; and a conventional laptop and/or palmtop receiver or other appliance that includes a radiotelephone transceiver. Mobile terminals may also be referred to as “pervasive computing” devices.

Some embodiments of the present invention arise from the use of a coherent light source in a communication device that further includes a housing with a translucent portion. The coherent light source may project light in one or more colors and the translucent material may serve as a light guide to conduct the coherent light through the surface of the device. As the coherent light diffuses into and spreads through the translucent material, it may be reflected and refracted out from the housing and into the eye of the viewer. The different paths taken by the coherent light coming from the communication device may randomly interfere with other photons generated by the coherent light source and cause a twinkle effect.

Further embodiments of the invention may use non-coherent light in addition to the coherent light. Coherent and non-coherent light sources imply that light visible to the human eye is produced. Infrared and ultraviolet light sources may be used as light generators, but they do not provide a visible effect. Some light sources, such as white light LEDs produce non-coherent light by first generating ultraviolet light and then using that source to pump fluorescent compounds, commonly known as phosphors, to create visible light. Some coherent light sources, such as green lasers, use an infrared laser diode to generate light, which is then applied to a frequency doubler crystal to generate green light in the visible spectrum. Embodiments of the present invention are not limited by the techniques used to generate coherent and non-coherent light within the visible spectrum. Visible light is typically considered to have wavelengths between about 400 and 700 nanometers.

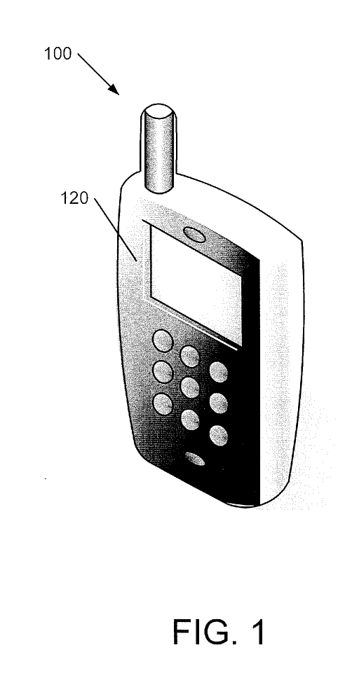

Referring now to FIG. 1, a communication device/mobile terminal 100, in accordance with some embodiments of the present invention, includes a housing 120 that at least partially surrounds communication circuitry and a coherent light source that is contained in the mobile terminal 100. The housing 120 includes a translucent portion through which light generated by the coherent light source may be projected. The coherent light travels through the translucent portion of the housing 120 where it is distributed through the surface of the housing and emitted to a viewer. The housing 120 may include overmolded plastic or other materials to create opaque portions of the housing so as to block the coherent light and allow the coherent light to escape at desired locations.

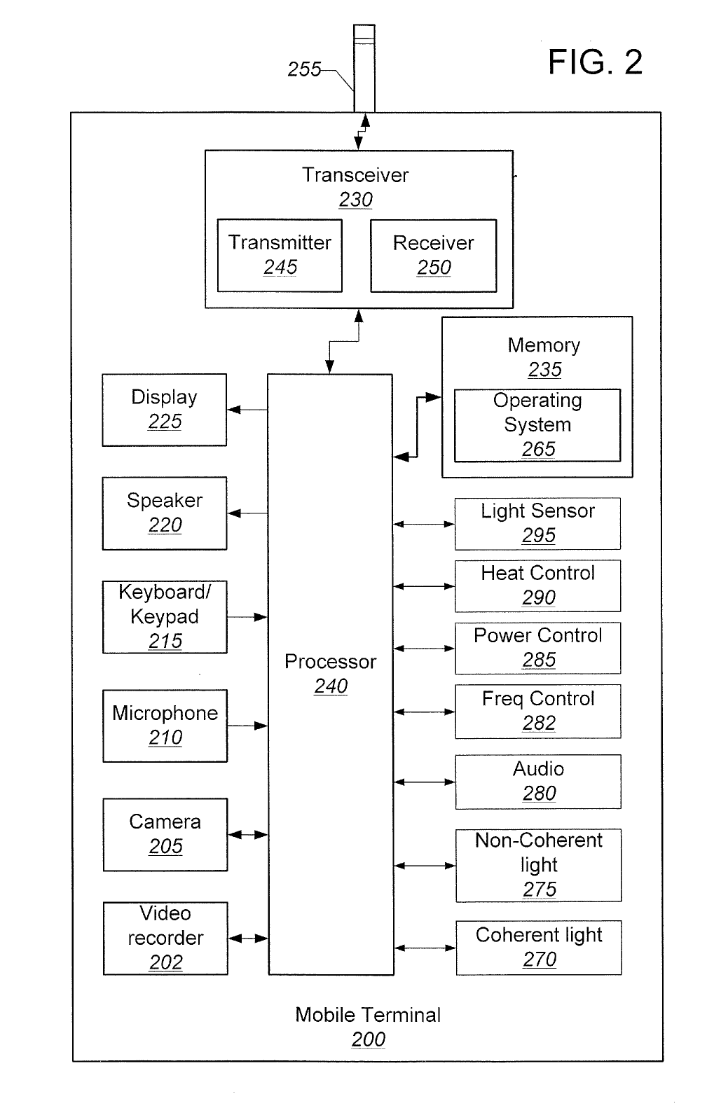

Referring now to FIG. 2, an exemplary mobile terminal 200 that may be used to implement the communication device/mobile terminal 100 of FIG. 1, in accordance with some embodiments of the present invention, includes a video recorder 202, a camera 205, a microphone 210, a keyboard/keypad 215, a speaker 220, a display 225, a transceiver 230, and a memory 235 that communicate with a processor 240. The transceiver 230 comprises a transmitter circuit 245 and a receiver circuit 250, which respectively transmit outgoing radio frequency signals to base station transceivers and receive incoming radio frequency signals from the base station transceivers via an antenna 255. The radio frequency signals transmitted between the mobile terminal 200 and the base station transceivers may comprise both traffic and control signals (e.g., paging signals/messages for incoming calls), which are used to establish and maintain communication with another party or destination. The radio frequency signals may also comprise packet data information, such as, for example, cellular digital packet data (CDPD) information. The foregoing components of the mobile terminal 200 may be included in many conventional mobile terminals and their functionality is generally known to those skilled in the art.

The processor 240 communicates with the memory 235 via an address/data bus. The processor 240 may be, for example, a commercially available or custom microprocessor. The memory 235 is representative of the one or more memory devices containing the software and data used to provide communication functionality as well as management of one or more light sources within the mobile terminal, in accordance with some embodiments of the present invention. The memory 235 may include, but is not limited to, the following types of devices: cache, ROM, PROM, EPROM, EEPROM, flash, SRAM, and DRAM. As shown in FIG. 2, the memory 235 may contain the operating system 265, which generally controls the operation of the mobile terminal 200. In particular, the operating system 265 may manage the mobile terminal's software and/or hardware resources and may coordinate execution of programs by the processor 240.

The mobile terminal further includes a coherent light source 270, a non-coherent light source 275, an audio module 280, a frequency control module 282, a power control module 285, a heat control module 290, and a light sensor module 295. The coherent light source 270 may, in some embodiments, be implemented as one or more laser diodes. Conventional laser diodes are available in red (670 nm and 635 nm), green (532 nm) and blue (473 nm) and many other frequencies. Multiple colors may be combined, in some embodiments, to enhance the aesthetic effect. Although the coherent light source 270 generates coherent light, the light need not be collimated. Collimation typically uses lenses to focus the light into a tight beam, which may cause ocular damage if the light were to ever escape without first being dispersed through the translucent housing portion of the mobile terminal 200.

The non-coherent light module 275 may be a conventional light module, which may project light to be combined with the coherent light generated by the coherent light module 270 to produce a desired aesthetic effect when exiting the translucent housing portion of the mobile terminal 200. The non-coherent light module 275 may be implemented, using, for example, a conventional light emitting diode or other suitable non-coherent light source.

The audio module 280 may be configured to play audio files, such as MP3 files or other audio encoding standard. The frequency control module 282 may generate an output signal that can be used to drive the coherent light source 270 so as to modulate the frequency of the coherent light output from the coherent light source 270. In some embodiments, the frequency control module 282 may generate its output signal responsive to an audio output signal from the audio module 280 so that the frequency of the light generated by the coherent light source 270 randomly varies in response to a music file or other type of audio file.

The coherent light source 270 may consume a significant amount of power. For example, laser diode current typically runs between around 20-60 milliamps. The power control module 285 may be configured to modulate power to the coherent light source 270 using, for example, pulse width modulation to enhance battery life of the mobile terminal 200. In some embodiments, the heat control module 290 may be used to monitor the internal temperature of the mobile terminal 200 and generate an output signal when the temperature rises above a threshold that the power control module 285 may use to reduce power to the coherent light source 270. The rise in temperature may be indicative that the coherent light source has been running for too long a time and/or at too great an intensity. Some laser diodes may have another diode created on the same substrate. This other diode does not create light, but can be used to measure the temperature of the laser junction and prevent or reduce thermal runaway. A control circuit may be implemented in hardware or partially implemented in software to avoid too much heat at the junction. Similarly, the ambient light sensor module 295 may be used to determine the intensity of the ambient light in the environment surrounding the mobile terminal 200 and to generate an output signal that can be used by the power control module 285 to reduce or increase power to the coherent light source 270 based on the environmental conditions.

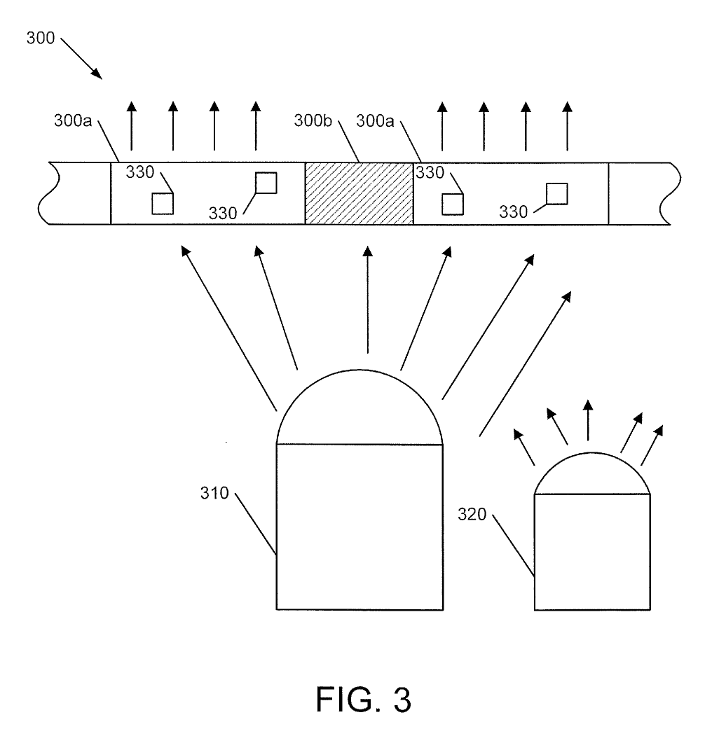

FIG. 3 is a diagram that illustrates the projection of light through the translucent portion of a housing of a mobile terminal in accordance with some embodiments of the present invention. As shown in FIG. 3, the housing 300 of a communication device, such as the mobile terminals 100 and 200 of FIGS. 1 and 2 includes a translucent portion 300a and may also include an opaque portion 300b that is configured to substantially block light emanating from inside the device/terminal. The device/terminal includes a coherent light source 310, such as the coherent light source 270 described above with respect to FIG. 2, and may also include a non-coherent light source 320, such as the non-coherent light source 275 described above with respect to FIG. 2. The device/terminal may include one or more optical components 330 that are designed to direct light from the coherent and/or non-coherent light sources 310 and 320. As shown in FIG. 2, one or more optical components 330, including, but not limited to, a lens, glitter, a mirror, and/or a diffraction grating may be molded into the housing 300. In other embodiments, the one or more optical components 330 may be arranged inside or on the surface of the device, but not inside the inner and outer surfaces of the housing 300. In some embodiments, one or more optical components 330 may be operable to move in response to an excitation signal. For example, the optical components 330 may include one or more microelectromechanical systems (MEMS), such as micro-mirrors that can be rotated in response to an excitation signal. In other embodiments, one or more optical components 330 may be placed on a speaker, such that the angle of reflection off the topical component(s) changes as the speaker moves when driven by an audio signal.

Depending on the desired aesthetic effect, the inner and outer surfaces of the housing 300 may be substantially smooth, distressed, or have some regions that are substantially smooth and some distressed regions. The translucent portion of the housing 300 may be constructed of materials that change the index of refraction within the translucent portion, e.g., two different material types may be used in the translucent portion such that an optical boundary exists where coherent light travels across the boundary and is refracted. For example, on or more portions of the housing 300 may have a knurled finish, which may change the way the light emanates from the housing 300 as compared to a substantially smooth finish. The housing 300 may also be flexible such that the polarization of the light passing through the housing changes based on the flex applied to the housing 300. As used herein, “flexing the housing” includes, but is not limited to, bending, stretching, and/or compressing the housing 300. Other techniques to change the polarization of the material may also be used in accordance with further embodiments of the present invention, such as the application of an external electric field to the housing.

As shown in FIG. 3, light from coherent light source 310 and, in some embodiments, the non-coherent light source 320, passes through the translucent portions of the housing 300a where it exits the device/terminal where it can be viewed. The translucent portions of the housing 300a may serve as a light guide allowing the coherent light signals to randomly add and subtract from one another as they diffuse through the housing 300. This creates an appearance of a sparkling effect when the light exits the housing 300. This visual effect may be pleasing to many users who value aesthetic qualities in communication devices. Moreover, the communication device/terminal may be used as a source of mood lighting in a room when the light is projected out from the housing of the device into the surrounding area and potentially on the surfaces of walls, ceilings, tables, and/or other structures.

Many variations and modifications can be made to the embodiments without substantially departing from the principles of the present invention. All such variations and modifications are intended to be included herein within the scope of the present invention, as set forth in the following claims.

That which is claimed:

1. A communication device, comprising:
communication circuitry;
a coherent light source; and
a housing that at least partially surrounds the communication circuitry and the coherent light source, the housing comprising a translucent portion and the coherent light source being configured so as to project light through the translucent portion of the housing.

2. The communication device of claim 1, wherein the housing further comprises an opaque portion that is configured to substantially block light from the light source from passing through the housing.

3. The communication device of claim 1, further comprising:
at least one optical component that is configured to direct the light projected from the coherent light source.

4. The communication device of claim 3, wherein the at least one optical component comprises a diffraction grating, a lens, glitter, and/or a mirror.

5. The communication device of claim 4, wherein the housing comprises the at least one optical component.

6. The communication device of claim 3, wherein the at least one optical component is operable to move responsive to an excitation signal.

7. The communication device of claim 6, further comprising:
an audio module that is configured to generate the excitation signal.

8. The communication device of claim 1, wherein the housing has an inner surface and an outer surface, the inner and outer surfaces being substantially smooth.

9. The communication device of claim 1, wherein the housing has an inner surface and an outer surface, at least one of the inner and outer surfaces being distressed.

10. The communication device of claim 1, wherein the translucent portion of the housing is manipulated such that a polarization of the light passing through the translucent housing is changed.

11. The communication device of claim 1, further comprising:
a non-coherent light source;
wherein the housing at least partially surrounds the non-coherent light source and the non-coherent light source is configured so as to project light through the translucent portion of the housing.

12. The communication device of claim 1, wherein the coherent light source comprises a laser diode.

13. The communication device of claim 1, further comprising:
a frequency modulator that is configured to generate an output signal;
wherein the coherent light source is configured to project light at a frequency that is based on the output signal of the frequency modulator.

14. The communication device of claim 13, further comprising:
an audio module that is configured to generate an audio signal;
wherein the frequency modulator is configured to generate the output signal responsive to the audio signal.

15. The communication device of claim 1, further comprising:
a power control module that is configured to modulate power to the coherent light source.

16. The communication device of claim 15, further comprising:
an ambient light sensor that is configured to generate an output signal based on an intensity of environmental light;
wherein the power control module is configured to modulate power to the coherent light source responsive to the output signal of the ambient light sensor.

17. The communication device of claim 15, further comprising:
a heat control module that is configured to generate an output signal based on a temperature internal to the communication device;
wherein the power control module is configured to modulate power to the coherent light source responsive to the output signal of the heat control module.

18. The communication device of claim 1, wherein the communication device is a mobile terminal, audio player, video player, memory stick, electronic headset, electronic toy, and/or an electronic game.

19. A method of operating a communication device, comprising:
at least partially surrounding communication circuitry and a coherent light source with a housing, the housing comprising a translucent portion; and
projecting light from the coherent light source through the translucent portion of the housing.

20. The method of claim 19, wherein the housing further comprises an opaque portion that is configured to substantially block light from the light source from passing through the housing.
